(19) United States
(12) Patent Application Publication
(10) Pub. No.: US 2019/0309214 A1
(43) Pub. Date: Oct. 10, 2019

(54) METHOD AND A SYSTEM FOR EXTRACTING FLUIDS

(71) Applicant: RELIANCE INDUSTRIES LIMITED, Mumbai (IN)

(72) Inventors: Timmie Dale SHEDD, Mumbai (IN); Rama Krishna Rao DONTHULA, Hyderabad (IN); Satish Kumar PANDEY, Gopalganj (IN)

(73) Assignee: RELIANCE INDUSTRIES LIMITED, Mumbai (IN)

(21) Appl. No.: 16/443,159

(22) Filed: Jun. 17, 2019

Related U.S. Application Data
(63) Continuation-in-part of application No. 15/518,562, filed on Apr. 12, 2017, now abandoned.

(30) Foreign Application Priority Data
Oct. 14, 2014 (IN) 3277/MUM/2014

(51) Int. Cl. C09K 8/584; E21B 43/16

(52) U.S. Cl. CPC C09K 8/584; E21B 43/16

(57) ABSTRACT

The present disclosure relates to a method and a system for improving recovery of fluids comprising natural gas and water from a reservoir via at least one oil/gas well connected to at least one flowline/pipeline network. For improving recovery of fluids, a composition containing a specific foaming composition is injected at a pre-determined location at the oil/gas well and/or the flowline/pipeline network. The foaming composition is delivered to the predetermined injection location via umbilical. The foaming composition is then naturally agitated with the water and converted to foam. The agitation is carried out by the natural gas. The foam formed reduces the interfacial surface tension between the natural gas and the water, and thereby facilitates reduction in liquid holdup in the flowline/pipeline network. The system of the present disclosure includes at least one primary manifold that merges flow from multiple wells, at least one secondary manifold that merges flow from multiple manifolds and a plurality of control valves and sensors.

### FIELD

The present disclosure relates to a method and a system for improving recovery of fluids from oil/gas wells. In particular, the present disclosure relates to a method and a system for improving recovery of hydrocarbons from the oil/gas wells by reducing liquid holdup in a flowline/pipeline network and thereby reducing backpressure on the oil/gas well.

### DEFINITIONS

As used in the present disclosure, the following words and phrases are generally intended to have the meaning as set forth below, except to the extent that the context in which they are used to indicate otherwise.

Backpressure—refers to a pressure within a system, which includes flowline/pipeline networks, oil wells, gas wells and sandface, caused by fluid friction, gravitation, restriction due to liquid holdup, or an induced resistance to flow through the system;

Critical velocity—refers to a velocity that a fluid attains when the gravity and the backpressure equalize on the available pressure of the fluid;

Reservoir—refers to a subsurface body of rock having sufficient porosity and permeability to store and transmit fluids;

Liquid holdup—refers to a cross sectional area of a multiphase pipeline occupied by the liquid in the pipe carrying the wet gas; and

MMscmd—refers to million metric standard cubic meter per day

XMT—refers to equipment (Christmas Tree) installed on the wellhead of an oil/gas well that controls flow of the well, isolates the well if required, provides injection points for chemicals as required, and monitors well pressure and flow.

### BACKGROUND

In search of new oil and gas production basins, oil and gas exploration has progressively moved further offshore and into water depths greater than previously explored. Inherent consequences of producing oil or gas from reservoirs that are discovered in deeper water includes an increase in system backpressure that is experienced downstream of the oil/gas well. Some of the contributing factors to the increased backpressure experienced at the deep water oil/gas wells are; the gradient change in elevation of the flowline/pipeline network, liquid fraction held up in the flowline/pipeline network, pressure losses due to fluid flow, and the higher velocity required to reduce the liquid holdup in the flowline/pipeline network.

In the early stages of production this backpressure is easily overcome with the initial pressure of the reservoir. However as the well advances into late life, the water fraction of the well's production may increase, the reservoir pressure depletes, and consequently the flowrate decreases, all of which results in increased backpressure at the well due to increased liquid holdup in the flowline/pipeline network.

Late life deepwater oil/gas wells may cease to flow early if the backpressure is not minimized as the well matures.

Wells that cease to flow early due to backpressure will reduce overall recovery of hydrocarbons from the well therefore it is necessary to take all available steps to minimize the backpressure at the well for sustained flow from the well as long as possible.

In order to maximize recovery of the hydrocarbon fluids from the oil/gas wells efficiently, it is necessary to reduce the backpressure experienced due to inherent flowline/pipeline system consequences that increase backpressure at the oil/gas wells.

Thus, there is felt a need for a method and a system to minimize inherent backpressure increase in oil/gas wells due to liquid holdup in the flowline/pipeline network and to overcome the above mentioned drawbacks.

### OBJECTS

Some of the objects of the present disclosure, which at least one embodiment herein satisfies, are as follows.

It is an object of the present disclosure to ameliorate one or more problems of the prior art or to at least provide a useful alternative.

An object of the present disclosure is to improve recovery of fluids from oil/gas wells.

Yet another object of the present disclosure is to reduce liquid holdup in flowline/pipeline networks.

Still another object of the present disclosure is to reduce backpressure on an oil/gas well.

Yet another object of the present disclosure is to reduce backpressure in flowline/pipeline networks

Other objects and advantages of the present disclosure will be more apparent from the following description, which is not intended to limit the scope of the present disclosure.

### SUMMARY

The present disclosure envisages a method and a system for improving recovery of hydrocarbons from an oil/gas well by minimizing backpressure experienced at the oil/gas well. The method of the present disclosure is carried out by injecting a foaming composition via subsea umbilical in an amount in the range of 0.3 to 1% (mass/mass) of the total liquid produced from the well at the subsea XMT. The foaming composition is then naturally agitated with the water and converted to foam incrementally as per the dosage of the foaming composition. The foam formed reduces the interfacial surface tension between the natural gas and the water flowing from the oil/gas well, and thereby facilitates reduction in liquid holdup in the downstream flowline/pipeline network.

In accordance with the present disclosure, the agitation of the foaming composition with the water is carried out by the natural turbulence created by the flow of the fluids being extracted from the reservoir via the oil well/gas well connected to the flowline/pipeline network.

### BRIEF DESCRIPTION OF ACCOMPANYING DRAWING

A method and a system for improving recovery of fluids from an oil/gas well via at least one flowline/pipeline network in accordance with the present disclosure will now be described with the help of the accompanying drawing, in which:

FIG. 1 illustrates a simplified flow chart depicting a system for improving recovery of fluids from oil /gas wells connected to a flowline/pipeline network in accordance with the present disclosure.

### DETAILED DESCRIPTION

The disclosure will now be described with reference to the accompanying embodiments which do not limit the scope and ambit of the disclosure. The description provided is purely by way of example and illustration.

The embodiments herein, the various features, and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Oil/gas wells are drilled in reservoirs to extract fluids from the reservoirs. Typically, the fluids in the reservoir include crude oil, hydrocarbon condensates, natural gas, and water.

During the initial stages when the oil/gas wells are drilled, the pressure of the fluids in the reservoir is adequate to facilitate the flow of the fluids from the reservoir to the oil/gas wells and downstream flowline/pipeline networks connected to the oil/gas wells, that facilitates produced fluids from the oil/gas wells to reach receipt facilities for further processing.

However, with time, extraction of the water increases, extraction of the hydrocarbon fluids (particularly natural gas) decreases and the pressures in the reservoir deplete, thereby decreasing the flow rate of the fluids. Due to this, the liquid holdup in the flowline/pipeline networks increases. The increased liquid hold-up results in:
an increased backpressure on the sandface, thereby inhibiting the flow of the hydrocarbon fluids from the reservoir; and
an additional backpressure in the oil/gas wells, thereby decreasing the extraction of the hydrocarbon fluids from the oil/gas wells. The backpressure exerted in the oil/gas wells affects the synergy (pressure balance) between the flowline/pipeline networks, the oil/gas wells and the reservoir, thereby affecting the extraction of the hydrocarbon fluids from the oil wells/gas wells.

The present disclosure, therefore, provides a method and a system for improving recovery of fluids from the reservoir via the oil/gas wells connected to the flowline/pipeline networks, by reducing the liquid holdup in the flowline/pipeline networks.

In accordance with the present disclosure, there is provided a method and a system improving recovery of the fluids comprising natural gas and water from a reservoir via at least one oil/gas well connected to at least one flowline/pipeline network.

The method of the present disclosure is carried out in the following steps:
in the first step, a composition containing a foaming composition is injected at the XMT of an oil/gas well and/or the flowline/pipeline network at a pre-determined location; and
in the second step, the foaming composition is naturally agitated with the water and some portion of the water is converted to foam, thereby reducing the interfacial surface tension between the natural gas and the water flowing from the oil/gas well and into the flowline/pipeline network, and thereby facilitating a reduction in liquid holdup in the flowline/pipeline network.

In accordance with the present disclosure, the foaming composition is agitated with the water by the natural turbulence occurring in the system as the production fluids are being extracted from the reservoir via the oil/gas well connected to the flowline/pipeline network.

Reduction in the liquid holdup in the flowline/pipeline network facilitates dynamic reduction in:
the backpressure on the sandface; and
the backpressure in the flowline/pipeline network, thereby improving recovery of the fluids, particularly natural gas.

Further, the reduction in the liquid holdup in the flowline/pipeline network facilitates in attaining a velocity more than the critical velocity required to unload the produced fluids in the flowline/pipeline network. The velocity of the gas more than the critical velocity is desired, so as to maintain minimum liquid holdup in the flowline/pipeline network and consequently maintain minimum backpressure on the oil/gas well.

Moreover, synergy or pressure balance is attained between the flowline/pipeline network, the oil/gas well, and the reservoir, on reduction in the liquid holdup in the flowline/pipeline network, thereby:
extending the life of the oil/gas well and the reservoir; and
facilitating additional extraction of the fluids from the reservoir via the oil well/gas well; and

In accordance with the present disclosure, injecting the foaming composition in an amount lesser than the minimum amount of the foaming composition into the XMT and/or the flowline/pipeline network results in an ineffective reduction in the liquid holdup in the flowline/pipeline network. Back pressure in such a scenario is not reduced adequately in the flowline/pipeline network to yield additional extraction of fluids from the reservoir. Ineffective decrease in the backpressure on the sandface, the reservoir and the flowline/pipeline network of the oil/gas well:
affects the synergy or pressure balance between the flowline/pipeline network, the oil/gas well and the reservoir; and
reduces the flow rate of the fluids below critical rate from the oil/gas well, thereby ceasing the oil well/gas well.

Therefore, the injection of the optimum amount of the foaming composition is required to minimize backpressure resulting from liquid holdup in the flowline/pipeline network and improve the recovery of fluids from the reservoir via the oil well/gas well.

In accordance with the present disclosure, at least one corrosion inhibitor is injected or present in the oil well/gas and/or the flow line network before injecting the foaming composition.

In accordance with the present disclosure, the pure corrosion inhibitor is injected in an amount up to 0.005% (mass/mass) of the total liquid.

In accordance with the present disclosure, the corrosion inhibitor is at least one selected from the group consisting of 2-butoxyethanol, ethylene glycol and 2-mercaptoethyl alcohol and is confirmed compatible with the foaming composition through laboratory testing.

In accordance with the present disclosure, the corrosion inhibitor is injected into the oil/gas well and/or the flowline/pipeline network to inhibit the corrosion in the flowline/pipeline network.

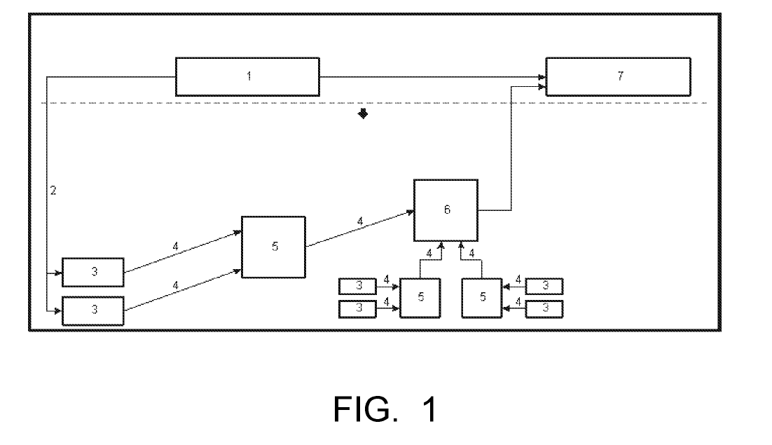

The system (depicted in FIG. 1) of the present disclosure comprises:
a chemical injection facility (1) for:
   injecting the foaming composition at the XMT (3) via subsea umbilical (2); and
   injecting de-foamer if required to avoid process system upset at the receipt facility during processing of the produced fluids.
at least one subsea XMT (3) that is connected to and in communication with downstream flowline/pipeline networks (4) including subsea primary manifolds (5) that merge produced fluid from multiple wells and a secondary manifold (6) that merges production from multiple upstream primary manifolds transporting the extracted fluids from the oil/gas well to a surface receipt facility.
a Receipt Facility (7) that receives and processes the fluids from an oil/gas well
a plurality of control valves and sensors (not shown in FIG. 1) for monitoring pressure, temperature and flow rate of the fluids.

Typically, the foaming composition (as shown in FIG. 1) is introduced into the produced fluid stream at the subsea XMT from the Chemical Injection Facility via the subsea umbilical. Natural agitation due to the turbulent environment of the produced fluid flowstream at the XMT is sufficient to initiate the foaming characteristics of the produced water and foaming composition. The foam stability is sufficient to aid in liquid holdup reduction in the flowline/pipeline network. The de-foaming agent is available to be injected from the Chemical Injection Facility at the Receipt Facility in case the foam remains stable at the time of receipt which would create process upset at the Receipt Facility.

In accordance with the present disclosure, the foaming composition includes:
mixture of surfactants in an amount in the range of 10 to 30% (mass/mass) of the total foaming composition;
ethylene glycol in an amount in the range of 30 to 60% (mass/mass) of the total foaming composition;
2-butoxyethanol in an amount in the range of 10 to 30% (mass/mass) of the total foaming composition;
isopropanol in an amount in the range of 1 to 5% (mass/mass) of the total foaming composition; and
quaternary ammonium compound in an amount in the range of 1 to 5% (mass/mass) of the total foaming composition.

In accordance with the present disclosure, the de-foaming agent is injected in an amount in the range of 0.1 to 0.2% (mass/mass) of the total produced liquid from the well, however de-foamer is only injected if necessary to prevent process upset at the Receipt Facility in case the induced foam remains stable up to the receipt of the produced liquids at the Receipt Facility.

In accordance with the present disclosure, the de-foaming agent is preferably kerosene.

The present disclosure is further described in light of the following experiments which are set forth for illustration purpose only and not to be construed for limiting the scope of the disclosure. The following examples can be scaled up to industrial/commercial scale.

Experiment-1: Foaming Composition Effectiveness

The specific foaming composition is chosen based on compatibility with other chemicals present in the system (corrosion inhibitor and MEG) and acceptability to be delivered through a subsea umbilical in addition to providing the desired foaming result.

Test methodology utilized is ASTM-D892 cylinder test. However additional information is gathered to quantify the effectiveness of the unloading of liquid holdup in the system while sparging 7 liters per minute through the liquid sample. The modified version of ASTM-D892 cylinder test uses a jacketed measuring cylinder fitted with a condensing arm that feeds a vessel on a balance. The liquid carried over indicates the efficiency of each dosage of foaming agent. The efficiency of the dosage rate is reflected as: % Unloading=WC/WInitial×100
Wₑ=Weight of liquid condensed from measuring cylinder
W_{Initial}=Weight of liquid (initial sample volume in measuring cylinder)

Estimated efficiency of unloading of liquid holdup is presented in Table-1 below.

TABLE 1

| Foaming Composition Dosage | Unloading Effciency |
|---|---|
| 0% | 0% |
| .3% | 6% |
| .5% | 42% |
| .75% | 47% |
| 1% | 77% |

Inference:

From the Table-1 above, it can be inferred that 0.3% dosage yields just 6% unloading efficiency which is considered insufficient to produce substantial reduction in liquid holdup (i.e reduced back pressure on the well due to liquid holdup), therefore dosage below 0.3% is not considered beneficial. Additionally, 1% dosage yields 77% unloading efficiency. Although it could be extrapolated based on Experiment 1 results, the results reflected in Table 1 present a range of predicted results per dosage that illustrate the lower end of effectiveness and the upper range of dosage that would become cost prohibitive. Therefore, use of more than 1% foaming composition is not cost effective.

Experiment-2: Application of Experiment 1 Data to Field Parameters

Dynamic simulations were performed to estimate the net reduction in backpressure anticipated with consideration of the unloading efficiency predicted in Experiment-1. The dynamic simulations were performed with typical industry flow assurance software. Simulation results are extrapolated to provide the estimated backpressure reduction per the estimated unloading efficiency of the foaming composition determined in Experiment-1.

Dynamic simulation and the extrapolated estimation of backpressure reduction are presented in Table-2 below.

TABLE 2

| | | | | Extrapolated |
|---|---|---|---|---|
| | Simulated | Simulated | Pressure | Pressure |
| | Pressure | Pressure | Reduction | Reduction |
| | (bara) | (bara) | (bara) | (bara) |
| | (0% Foam | (100% Foam | (100% Foam | (42% Foam |
| | Aqueous | Aqueous | Aqueous | Aqueous |
| | Phase) | Phase) | Phase) | Phase) |
| Well B1 | 69.7909 | 63.0455 | 6.7454 | 2.833 |
| (Downstream | | | | |
| XMT) | | | | |
| Well B2 | 67.4827 | 63.609 | 3.8737 | 1.627 |
| (Downstream | | | | |
| XMT) | | | | |
| Primary | 67.1726 | 61.9224 | 5.2502 | 2.205 |
| Manifold | | | | |
| Secondary | 58 | 58 | Taken as | Taken as |
| Manifold | | | Constant | Constant |

Inference:

From the Table-2 above, it can be inferred that Well B-1 downstream-of-well pressure is 69.7909 bara measured pressure with no foaming agent considered. Simulated downstream pressure with 100% foam in aqueous phase is 63.0455 bar which represents pressure reduction at the well of 6.7454 bara. 42% of 6.7454 bara (2.833 bara) reduction in backpressure at the well is predicted at 0.5% dosage of foaming agent per Table 1 results. Reduction of 2.833 bara in the overall depletion of a well is significant to give additional recovery.

### EXAMPLE-1

### Effect of a Foaming Composition

Two oil/gas wells, namely B1 and B2, were drilled. With the continuous extraction of the natural gas from the wells, B1 and B2, the flow rate of the natural gas from the respective wells, B1 and B2, decreased to 0.368 and 0.940 MMscmd, respectively. Flowrate decrease is attributed to lower reservoir pressure due to depletion and increased backpressure in the flowline/pipeline network due to liquid holdup. Therefore, in order to increase the flow rate of the natural gas, a foaming composition comprising a 10 to 30% mixture of surfactants (mass/mass) of the total foaming composition, 30 to 60% ethylene glycol (mass/mass) of the total foaming composition, 10 to 30% 2-butoxyethanol (mass/mass) of the total foaming composition, 1 to 5% isopropanol (mass/mass) of the total foaming composition and 1 to 5% quaternary ammonium compound (mass/mass) of the total foaming composition was injected at the XMT of the oil/gas wells, B1 and B2.

Measured variation in the system parameters and flow rates of the natural gas before and after injecting the foaming composition for 24 hours are tabulated in Table-3.

TABLE 3a
Well Flowrate Response

| | Foaming | | Well Flow rate | |
|---|---|---|---|---|
| | Composition | | (24 hours | |
| | Dosage | Well Flow rate | Foaming | Flow rate |
| | (PPM/Total | (Initial) | Composition) | Increase |
| Well | Liquid Produced) | MMscmd | MMscmd | MMscmd |
| B1 | 3380 | .368 | .532 | .164 |
| B2 | 5000 | .940 | .971 | .031 |

TABLE 3b
Flowline/Pipeline Pressure Response

| | Flowline/Pipeline Network | | |
|---|---|---|---|
| | | Flowline/Pipeline | |
| | Flowline/Pipeline | Network | Flowline/Pipeline |
| | Network | (24 hours | Network |
| | Parameters | Foaming | Pressure |
| | (Initial) | Composition) | Reduction |
| | (bara) | (bara) | (bara) |
| Well Bl | 65.51 | 61.75 | 3.76 |
| (Downstream | | | |
| XMT) | | | |
| Well B2 | 63.23 | 60.7 | 2.53 |
| (Downstream | | | |
| XMT) | | | |
| Primary | 61.93 | 59.4 | 2.53 |
| Manifold | | | |
| Secondary | 54.43 | 55.59 | −1.16 |
| Manifold | | | |

TABLE 3c
Flowline/Pipeline Differential Pressure Response:

| | Flowline/Pipeline Network | | |
|---|---|---|---|
| | | Differential | |
| | | Pressure | |
| | Differential | (24 hours | Differential |
| | Pressure | Foaming | Pressure |
| | (Initial) | Composition) | Decrease |
| | (bara) | (bara) | (bara) |
| Well B1 > Primary | 3.58 | 2.35 | .164 |
| Manifold | | | |
| Well B2 > Primary | 1.3 | 1.3 | 0 |
| Manifold | | | |
| Primary Manifold > | 7.5 | 3.81 | 3.69 |
| Secondary Manifold | | | |

Inference:

From the Table-3a above, it is inferred that in case of well B 1, where foaming composition dosage is 3380 (PPM/Total Liquid Produced), increased gas flow rate of 0.164 MMscmd is observed with 24 hours of foaming Similarly, in case of well B2, where foaming composition dosage is 5000 (PPM/Total Liquid Produced) increased the flow rate of 0.031 MMscmd is observed after 24 hours of foaming.

From the Table-3b above, it can be inferred that pressure reduction of 3.76 bara is observed in case of Well B1 (downstream XMT) flow line/pipe line network after 24 hours of foaming Similarly In case of Well B2 (downstream XMT), it is inferred that pressure reduction of 2.53 bara is observed in flow line/pipe line network after 24 hours of foaming.

From the Table-3c above, it is inferred that there is a differential pressure decrease of 0.164 bara from well B1 to primary manifold after 24 hours of foaming, wherein in the well B1 is at higher pressure as compared to the primary manifold. Similarly from primary manifold to secondary manifold there is a differential pressure decrease of 3.69 bara after 24 hours of foaming, wherein in the primary manifold is at higher pressure as compared to the secondary manifold, facilitating liquid flow.

Technical Advances and Economical Significance

The present disclosure described herein above has several technical advantages including, but not limited to, the realization of a method and a system that:
decreases the liquid hold-up in the oil wells/gas wells and/or the flow line networks, thereby:
   decreasing the backpressure:
      on the sandface of the reservoir;
      in the oil/gas wells; and
      in the flowline/pipeline networks; and
   facilitating in maintaining synergy (pressure balance) between the flowline/pipeline networks, the oil/gas wells and the reservoir, to improve recovery of fluids, particularly natural gas, from the reservoir via the oil/gas wells.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

We Claim:

1) A method for improving recovery of fluids comprising oil/gas from a reservoir via at least one oil/gas well connected to at least one flowline/pipeline network, said method comprising:
a. injecting a composition containing a foaming composition in an amount in the range of 0.5% to 1% (mass/mass) of the total produced liquid at a pre-determined location into the at least one oil/gas well and/or the at least one flowline/pipeline network,
wherein said foaming composition comprises:
mixture of surfactants in an amount in the range of 10 to 30% (mass/mass) of the total foaming composition;
ethylene glycol in an amount in the range of 30 to 60% (mass/mass) of the total foaming composition;
2-butoxyethanol in an amount in the range of 10 to 30% (mass/mass) of the total foaming composition;
isopropanol in an amount in the range of 1 to 5% (mass/mass) of the total foaming composition;
quaternary ammonium compound in an amount in the range of 1 to 5% (mass/mass) of the total foaming composition;
b. allowing the natural gas to agitate said foaming composition and convert at least a portion of the water to foam, thereby reducing the interfacial surface tension between the natural gas and the water flowing from the oil/gas well to a flowline/pipeline network, and thereby facilitating reduction in liquid holdup in the at least one flowline/pipeline network.

2) The method as claimed in claim 1, wherein said composition includes injecting a de-foaming agent in an amount in the range of 0.1 to 0.2% (mass/mass) of the total produced liquid at the receipt facility to de-stabilize the foam, if required, to prevent process upset at the receipt facility

3) The method as claimed in claim 2, wherein said de-foaming agent is kerosene.

4) A system for improving recovery of fluids comprising natural gas from a reservoir via at least one oil/gas well connected to at least one flowline/pipeline network, said system comprising:
a chemical injection facility for:
injecting the foaming composition at the XMT via subsea umbilical; and,
injecting de-foamer if required to avoid process system upset at the Receipt Facility during processing of the produced fluids.
at least one subsea XMT that is connected to and in communication with downstream flowline/pipeline networks including subsea primary manifolds that merge produced fluid from multiple wells and a secondary manifold that merges production from multiple upstream primary manifolds transporting the extracted fluids from the oil/gas well to a surface receipt facility.
a receipt facility that receives and processes the fluids from an oil/gas well
a plurality of control valves and sensors for monitoring pressure, temperature and flow rate of the fluids.
